(19) United States
(12) Patent Application Publication
(10) Pub. No.: US 2015/0000094 A1
(43) Pub. Date: Jan. 1, 2015

(54) CONVERSION OF A MECHANICAL TIMECLOCK ENCLOSURE

(71) Applicant: ZODIAC POOL SYSTEMS, INC., Vista, CA (US)

(72) Inventor: David Andrew Goldman, Carlsbad, CA (US)

(21) Appl. No.: 14/316,464

(22) Filed: Jun. 26, 2014

Related U.S. Application Data
(60) Provisional application No. 61/839,465, filed on Jun. 26, 2013.

(51) Int. Cl. B23P 19/04

(52) U.S. Cl. CPC B23P 19/04
USPC 29/402.03

(57) ABSTRACT

Systems and methods of retrofitting an existing mechanical time clock enclosure to an Internet controllable, electronic pool and/or spa controller with improved, multi-functionality. In some instances, the conversion can be made without the need for adding new, additional enclosures (and corresponding wiring) and can expand the functionality of the controller to operate one or more valve actuators, one or more circuits, provide two-way communication with variable speed pumps and/or allow the electronic controller to access and/or be controlled by the Internet or with interface software.

### CROSS REFERENCE TO RELATED APPLICATION

This application is related to and claims priority benefits from U.S. Provisional Application Ser. No. 61/839,465 filed on Jun. 26, 2013, entitled CONVERTING A MECHANICAL TIMECLOCK ENCLOSURE TO ENCLOSE AN INTERNET CONTROLLABLE POOL CONTROLLER, the entire contents of which are incorporated herein by this reference.

### FIELD OF THE INVENTION

The invention relates to retrofitting enclosures for pool and spa controllers.

### BACKGROUND

Mechanical and electromechanical time clocks have long been used to control operation of equipment associated with pools and spas, including, but not limited to, pumps, water jets, lights, heaters, active filters, etc. These mechanical time clocks are often housed in one or more enclosures located near the pool/spa equipment, such as enclosure 10 shown in FIG. 1. In some instances, the enclosure is configured to accommodate more than one mechanical time clock, such as enclosure 110 shown in FIG. 2, which is designed to accommodate two mechanical time clocks 112.

As an alternative to mechanical time clocks, digital time clocks are used to electronically control operation of the selected equipment. In some instances, it is desirable to utilize an existing mechanical enclosure by retrofitting the mechanical time clock enclosure to accommodate a digital time clock. Utilizing the existing enclosure allows the existing wiring to be used instead of installing new wiring and avoids the need to mount a new time clock housing.

Currently, digital timers that can be retrofit into an existing mechanical enclosure have limited functionality. For example, the P7000ME and P1000ME Series timers offered by Intermatic® are only capable of controlling up to three or four relays respectively and, thus, can only operate up to three or four, respectively, pieces of equipment, and are not capable of controlling any valve actuators. As another example of a retrofit timer with limited functionality, the P4000ME Series timer offered by Intermatic® is only capable of operating up to three valve actuators and is not capable of operating any relays and therefore is not capable of controlling any equipment. As yet another example of a retrofit timer with limited functionality, the P4243ME Series timer offered by Intermatic® is only capable of operating up to three valve actuators and up to three relays.

None of the above digital timers are capable of communicating with the Internet or being Internet-controlled, offering wireless remote control or wired weatherproof or waterproof remote control, or engaging in two-way communication with a variable speed pump. To communicate with a variable speed pump, a second time clock would need to be introduced into the system, and this second time clock would need to be mounted in a second enclosure and electrically connected to other system components.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Disclosed herein are systems and methods for retrofitting a mechanical or electromechanical enclosure with a digital time clock with expanded functionality. For example, the disclosed systems and methods convert an existing mechanical enclosure into one that houses a digital time clock capable of controlling one or more relays, one or more valves, communicating with and/or being controlled via the Internet and communicating with and/or being controlled via the Internet using a suitable software interface application (“apps”), offering wireless remote control or wired weatherproof or waterproof remote control and/or engaging in two-way communication with a variable speed pump.

### BRIEF DESCRIPTION OF THE DRAWINGS

FIG. 1 is a perspective view of a conventional mechanical time clock housed in a single enclosure.

FIG. 2 is a perspective view of two conventional mechanical time clocks housed in a double wide enclosure.

FIG. 3 is a perspective view of a first retrofitted enclosure according to one embodiment of the invention.

FIG. 4 is a perspective view of a second retrofitted enclosure according to another embodiment of the invention.

FIG. 5 is a perspective view of a third retrofitted enclosure according to yet another embodiment of the invention.

FIG. 6 is a perspective view of a chassis coupled with a user interface according to another embodiment of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide methods and systems for retrofitting a conventional mechanical time clock enclosure to accommodate an electronic controller with expanded functionality. As described in more detail below, the disclosed electronic controller may be used to control various aspects of pools and spas and may communicate with the Internet and be controllable by the Internet. In some instances, the electronic controller communicates with and is controllable by apps via the Internet. In some embodiments, the disclosed electronic controller that retrofits into the existing mechanical enclosure controls one or more relays and one or more valves. In some embodiments, the disclosed electronic controller that retrofits into the existing mechanical enclosure offers multiple remote options such as wireless remote control, Internet remote control, and wired weatherproof or waterproof remote control. In some embodiments, the disclosed electronic controller that retrofits into the existing mechanical enclosure engages in two-way communication with a variable speed pump.

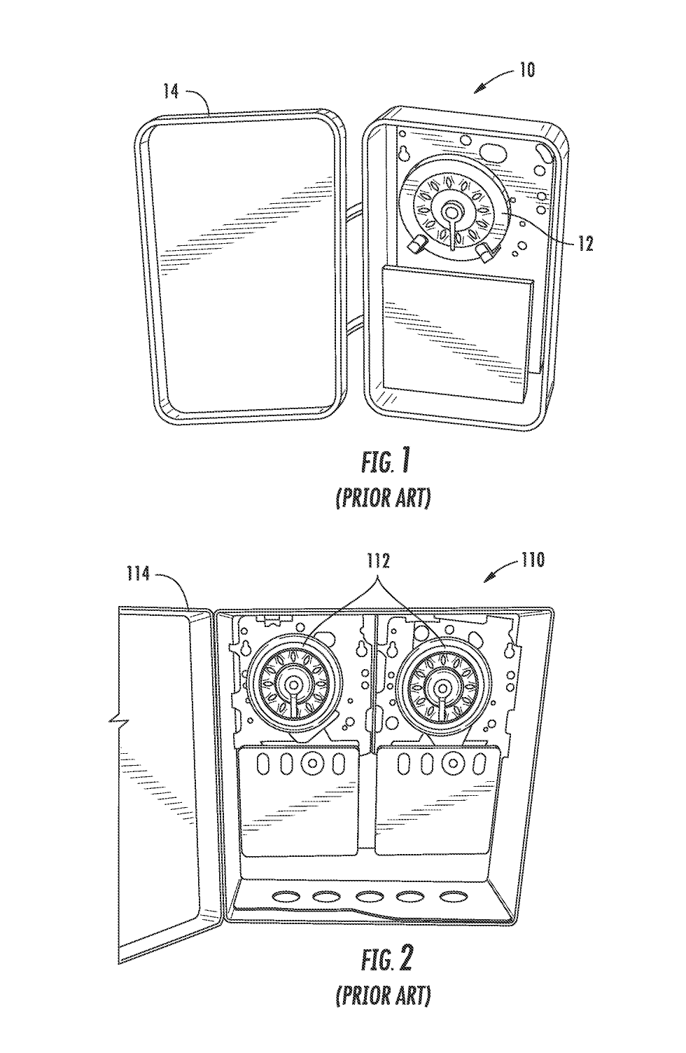

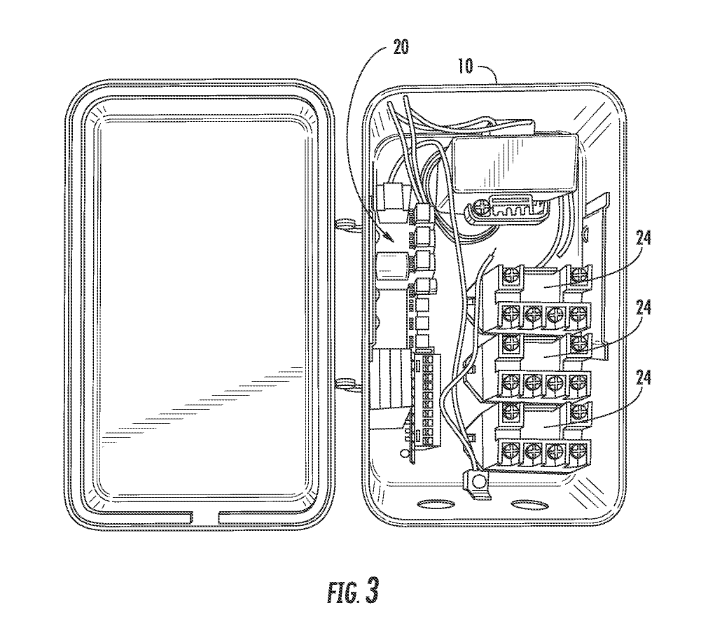

Illustrated in FIG. 1 is an example of an existing enclosure 10 that houses a mechanical time clock 12. Enclosure 10 is illustrated as generally rectangular, although existing enclosure 10 may have any suitable configuration. Enclosure 10 includes a hinged cover 14 attached to enclosure 10 and that covers time clock 12. FIG. 2 is another example of an existing wider, dual enclosure 110 that houses two mechanical time clocks 112. Enclosure 110 is illustrated as generally square, although enclosure 10 may have any suitable configuration. Similar to enclosure 10, enclosure 110 includes a hinged cover 114 attached to enclosure 110 and that covers time clocks 112. Time clocks 12 and 112 are coupled with any desired pool or spa equipment to control operation of that piece of equipment. For example, mechanical time clocks 12 or 112 may engage with valve actuators or may control operation of a pump, water jets, lights, heaters, active filters, etc.

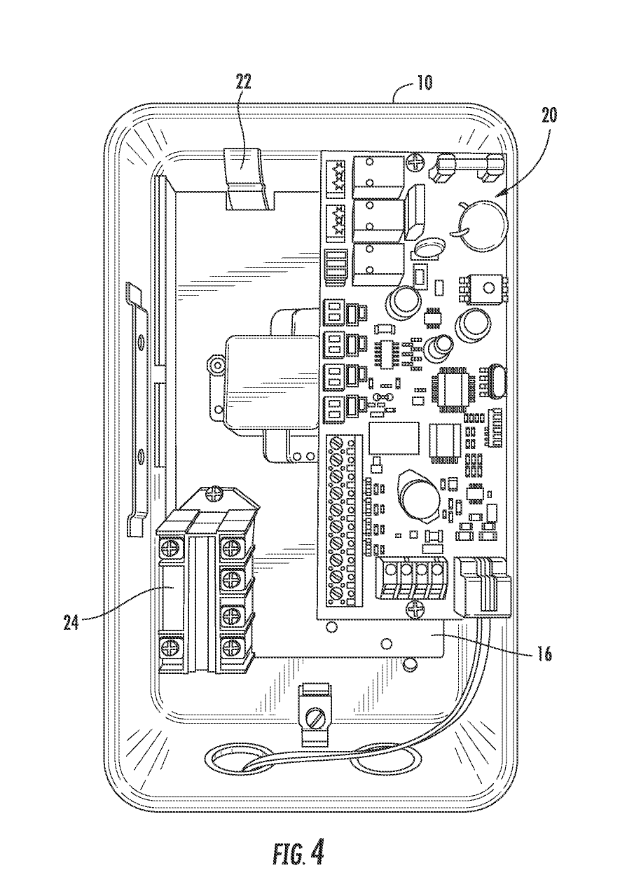

When replacing a mechanical time clock such as time clock 12 or 112 with a digital time clock or other electronic controller, it may be desirable to utilize the existing enclosure rather than completely replace the existing enclosure with a new enclosure. Utilizing the existing enclosure eliminates the need for new electrical wiring, among other things. FIGS. 3-6 illustrate various examples according to aspects of this invention where existing enclosures have been retrofit to accommodate electronic controllers.

Specifically, FIG. 3 illustrates existing enclosure 10 after the mechanical time clock 12 has been removed and replaced with an electronic controller 20. Electronic controller 20 is a circuit board with improved, multi-functionality and logic and communication protocols. For example, electronic controller 20 communicates with one or more relays (illustrated in FIG. 3 with three relays 24) for controlling one or more circuits and is also configured to control one or more valve actuators. In this way, electronic controller 20 is capable of simultaneously operating one or more valve actuators and using one or more relays to control one or more circuits. In some embodiments, electronic controller 20 is capable of operating up to three valves and up to four relays, although electronic controller 20 can be configured to operate any suitable number of valves and relays.

Moreover, electronic controller 20 has the ability to connect to the Internet and to be controllable from the Internet. In some instances, the electronic controller is accessible and/or controllable via the Internet using a suitable software interface application. In some embodiments, electronic controller 20 is capable of two-way communication with a variable speed pump, such that electronic controller 20 can both send and receive signals to the pump to control the pump and also ensure it is operating correctly.

FIG. 4 is another example of an existing enclosure 10 after the mechanical time clock 12 has been removed and replaced with an electronic controller. The electronic controller 20 of the embodiment of FIG. 4 has similar functionality as electronic controller 20 described above, but is mounted on a chassis 16 that can be easily and quickly snap-fit into existing enclosure 10 without the use of tools for easy repair and replacement. In the embodiment shown in FIG. 4, chassis 16 includes one relay 24, although more than one relay 24 could be included if desired. Alternatively, no relays may be included on chassis 16, and instead a second chassis may be used, as explained below, to hold one or more relays as space permits. In this way, the functionality for controlling a plurality of valve actuators and a plurality of relays, etc. is mounted on one or two chasses that fit within a single existing enclosure.

In some embodiments, chassis 16 snap-fits into an existing enclosure by means of a spring clip 22 or other suitable means. Chassis 16 is sized and shaped and otherwise designed to fit within the confines of existing mechanical enclosures, such as enclosures 10 or 110. In this way, electronic controller 20 is configured to be small enough to fit on a chassis 16 that in turn is small enough to fit within a standard enclosure such as enclosure 10 or enclosure 110.

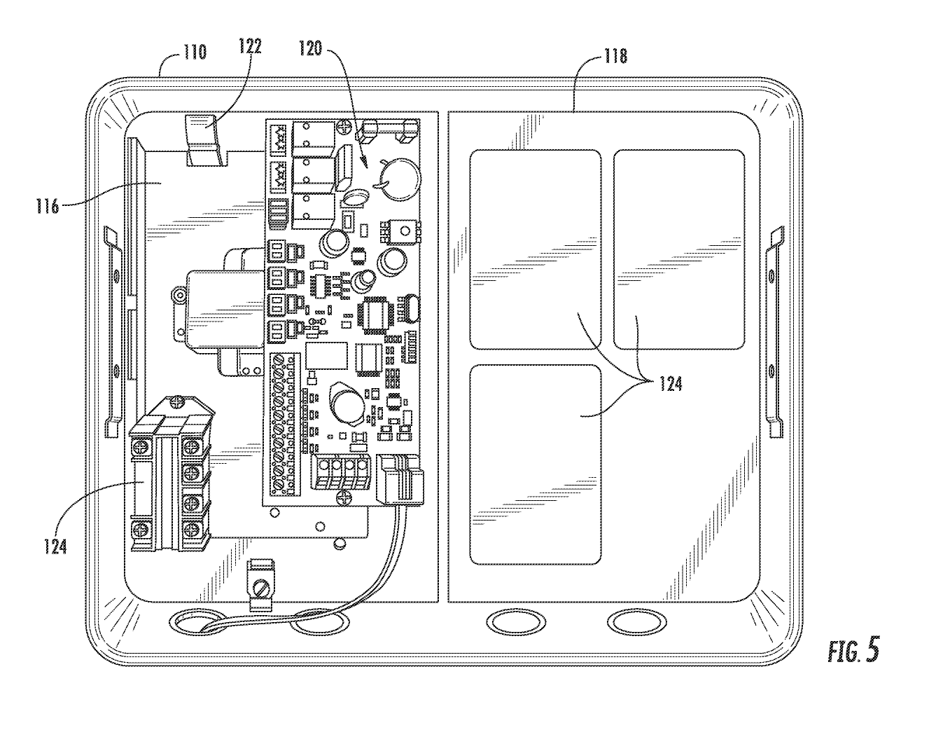

FIG. 5 is a perspective view of an example of an existing double wide enclosure 110 after the two mechanical time clocks 112 have been removed. The first mechanical time clock has been replaced with an electronic controller 120 mounted on a chassis 116 that can be snap-fit into the existing enclosure 110 via a spring clip 122 or other suitable mechanism as described above. Electronic controller 120 mounted on chassis 116 can have the functionality described above (i.e., may capable of controlling one or more of valve actuators, one or more relays, communicating with and being controllable by the Internet, engaging in two-way communication with a variable speed pump, etc.). As illustrated in FIG. 5, electronic controller 120 mounted on chassis 116 has one relay 124. As also shown in FIG. 5, the second mechanical time clock 112 has been replaced with a second chassis 118. Second chassis 118 may include one or more additional relays (three additional relays 124 are illustrated with representative boxes in FIG. 5) or other functionality such as, but not limited to, one or more RF transponders, electrical transformers, salt water chlorinator controllers, networking equipment, etc., and be intelligently controlled by the electronic controller 120 of chassis 116.

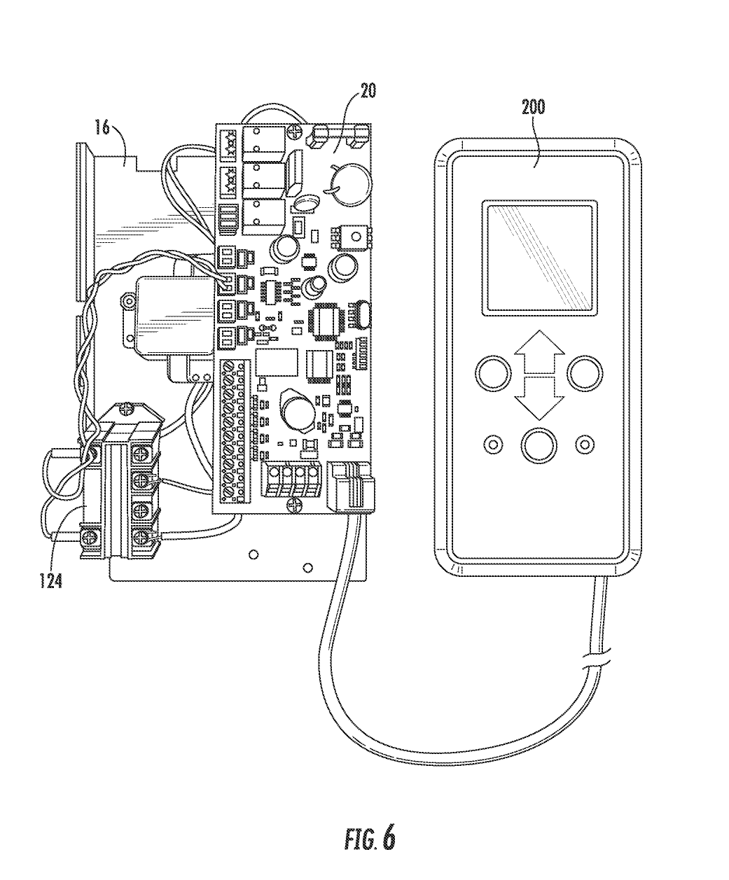

In some embodiments, the electronic controller, such as electronic controller 20 or 120, is configured to couple with a wired, weatherproof user interface such as the user interface 200 illustrated in FIG. 6. Such a wired, weatherproof user interface does not require batteries and can be placed outside without the need for additional enclosures and in closer proximity to the pool or spa itself.

As described in detail above, the disclosed electronic controller may be configured to fit within a single existing enclosure and have multi-functionality such as any suitable combination of: two-way communication with a variable speed pump; operation of one or more pool valve actuators for pool/spa feature control and/or solar heater control; operation of one or more relays; and/or ability to be communicated with and be controlled via the Internet or with interface software. In this way, it is possible to retrofit an existing enclosure to house a digital time clock with any or all of the above functionality without adding additional controllers, additional enclosures or additional conduit.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A method of retrofitting an existing pool mechanical time clock enclosure, the method comprising:
removing a mechanical time clock housed within the existing pool mechanical time clock enclosure;
installing a single chassis within the existing pool mechanical time clock enclosure, wherein the single chassis comprises an electronic controller capable of:
controlling one or more valve actuators;
controlling one or more circuits;
two-way communication with a variable speed pump; and
communicating with the Internet.

2. The method of claim 1, wherein installing the single chassis within the existing pool mechanical time clock enclosure comprises snap-fitting the single chassis into the existing pool mechanical time clock enclosure without use of tools.

3. The method of claim 1, wherein the electronic controller is capable of being controlled via the Internet.

4. The method of claim 3, wherein the electronic controller is capable of being accessible via the Internet using a suitable software interface application.

5. The method of claim 1, further comprising:
removing a second mechanical time clock housed within the existing pool mechanical time clock enclosure;
installing a second chassis within the existing pool mechanical time clock enclosure; and
controlling functionality of the second chassis via the electronic controller of the single chassis.

6. The method of claim 5, wherein the controlling the functionality of the second chassis comprises controlling additional circuits.

7. The method of claim 1, further comprising coupling the electronic controller with a wired, weatherproof user interface.

8. A method of converting an existing pool mechanical time clock enclosure into an electronic controller, the method comprising replacing a mechanical time clock housed within the existing pool mechanical time clock enclosure with an electronic controller mounted on a single chassis within the existing pool mechanical time clock enclosure, wherein electronic controller is capable of:
controlling one or more valve actuators;
controlling one or more circuits; and
communicating with the Internet.

9. The method of claim 8, wherein installing the electronic controller further comprises installing an electronic controller capable of two-way communication with a variable speed pump.

10. The method of claim 8, wherein installing the electronic controller further comprises installing an electronic controller capable of being accessible via the Internet using a suitable software interface application.

11. The method of claim 8, further comprising:
replacing a second mechanical time clock housed within the existing pool mechanical time clock enclosure with a second chassis such that the second chassis is mounted within the existing pool mechanical time clock enclosure; and
controlling functionality of the second chassis via the electronic controller of the single chassis.

12. The method of claim 11, wherein the controlling the functionality of the second chassis comprises controlling additional circuits.

13. The method of claim 8, further comprising coupling the electronic controller with a wired, weatherproof user interface.

14. A method of retrofitting a mechanical time clock pool enclosure such that a plurality of valves and a plurality of circuits can be controlled via the Internet.

15. The method of claim 14, wherein the plurality of valves and the plurality of circuits can be controlled via the Internet using a suitable software interface application.
